(19) United States
(12) Patent Application Publication
(10) Pub. No.: US 2001/0050774 A1
(43) Pub. Date: Dec. 13, 2001

(54) IMAGE PROCESSING DEVICE

(75) Inventors: SHINICHI SATO, YOKOHAMA-SHI (JP); KAZUYUKI NISHIMURA, ICHIKAWA-SHI (JP); YOSHIKAZU NAITO, YOKOHAMA-SHI (JP); FUMIKO KOSHIMIZU, MACHIDA-SHI (JP)

Correspondence Address: GREENBLUM & BERNSTEIN, P.L.C., 1941 ROLAND CLARKE PLACE, RESTON, VA, 20191, US

(73) Assignee: Matsushita Graphic Communication systems, Inc., Tokyo (JP)

(21) Appl. No.: 09/108,236

(22) Filed: Jul. 1, 1998

(30) Foreign Application Priority Data
Jul. 15, 1997 (JP) 9-205294

(51) Int. Cl. G06K 15/02; H04N 1/50

(52) U.S. Cl. 358/1.1; 358/501

(57) ABSTRACT

An image processing device has a color/monotone common image processing section to execute a series of image processing corresponding to a monotone image having an external output terminal to take out an intermediate processing data to an external and an external input terminal to take in an image data color processed from an external section into an intermediate section. The data provided into the intermediate section of the color/monotone common image processing section is selected from the image data from the input terminal and the intermediate processing data from the former section of the color/monotone common image processing section.

### BACKGROUND OF THE INVENTION

1. Field of the Invention

The present invention relates to an image processing device applicable for an apparatus which has an equipment corresponding to color indication for dealing with color images such as facsimile device, copy machine and so on and an equipment corresponding to monotone indication for dealing with only monotone images.

2. Description of the Related Art

There has been a color facsimile apparatus since before which reads color information from a color original paper and transmits it, or receives and records a color image. The color facsimile apparatus generally comprises a color processing function for executing color correction of color image and other processings and a function for transforming RGB color image data into YMCK data appropriate for a color printer.

On the other hand, a facsimile apparatus, copy machine or others currently spread wide is a monotone indication facsimile apparatus which can not deal with a color image. In some of facsimile devices, a monotone imaging processing circuit can be detached, and by exchanging a monotone imaging processing circuit with a color image processing circuit, a monotone facsimile apparatus can be converted into a color facsimile device.

However, in the conventional case of converting a monotone facsimile apparatus into a color facsimile apparatus, there are problems that it is expensive and requires many processes because it is necessary to exchange the whole circuit from the monotone imaging processing circuit to the color image processing circuit.

### SUMMARY OF THE INVENTION

The present invention is carried out based on the facts as described above and has an object to provide an image processing device capable of transforming a monotone image processing device into a color image processing device easily and inexpensively only by installing a color optional circuit.

This object is achieved by an image processing device in which an image processing system for executing a series of image processing corresponding to monotone images also executes a part of color image processing common to the monotone image processing.

### BRIEF DESCRIPTION OF THE DRAWINGS

FIG. 1A and FIG. 1B are function block diagrams of an color/monotone image processing device according to the embodiment of the present invention;

FIG. 2 is a function block diagram of a horizontal scanning direction scaling section in the color/monotone image processing device according to the embodiment described above.

FIG. 3 is a function block diagram of a binary processing/error diffusion section in the color/monotone image processing device according to the embodiment described above;

FIG. 4A and FIG. 4B are configuration diagrams of error diffusion filters in the color/monotone image processing device according to the embodiment described above;

FIG. 5 is a function block diagram of color correction section in the color/monotone image processing device according to the embodiment described above;

FIG. 6 is a function block diagram of a white balance correction data calculating section in the color/monotone image processing device according to the embodiment described above;

FIG. 7A and FIG. 7B are concept diagrams of a memory map in each input mode in the color/monotone image processing device according to the embodiment described above; and

FIG. 8 is a concept diagram of another memory map in the color/monotone image processing device according to the embodiment described above.

### DETAILED DESCRIPTION OF THE PREFRRED EMBODIMENT

The present invention takes following means to solve the problems described above.

The image processing device in the present invention has the constitution where an image processing system for executing a series of image processing corresponding to monotone images also executes a part of color image processing common to the monotone image processing.

According to the constitution described above, in the case of upgrading a monotone image processing device to a color image processing device by connecting a color optional circuit to it, the color optional circuit needs only minimum functions, which makes upgrading easily and inexpensively possible.

And, the image processing device in the present invention has a color/monotone common image processing section comprising an image processing system for executing a series of image processing corresponding to a monotone image, an external output section for taking out intermediate processing data from the image processing system to an external, an external input section for taking in color processed image data from the external to an intermediate section of the image processing system and a selector to select either of the image data provided from the external input section and the intermediate processing data provided from a former section of the image processing system to obtain the data to the intermediate section of the image processing system.

By installing a color optional circuit in the color/monotone image processing section having a function as a monotone image processing device, it can be transformed into a color image processing device easily with keeping a current monotone image processing circuit active.

In the image processing device in the present invention, a color/monotone common image processing section is connected to a color image processing section for color processing an intermediate processing data provided from an external output section so as to input to an external input section.

According to the constitution described above, by installing a color image processing section in a color/monotone common image processing section as a color optional circuit, a device can be easily transformed into a color image processing device without exchanging the whole device. In this case, the color optional circuit needs only minimum functions because a monotone image processing circuit also executes a part of color image processing, which makes inexpensive downsizing possible.

For example, by installing an optional color processing section circuit (color correction circuit, YMCK transformer, memory) composing a color image processing section to the color/monotone common image processing section, upgrading into a color image processing device can be achieved with keeping the main part of the image processing section usable.

In the image processing device in the present invention, an image processing section comprises a color transforming output section for taking in RGB image data output from an image processing system from color/monotone common image processing section and color transforming it into the color system data appropriate for an external equipment to output.

According to the constitution described above, in the case of installing an optional color processing circuit in a monotone image processing circuit, output from the monotone image processing circuit can be transformed into the data appropriate for an external equipment such as color printer and so on.

In the image processing device in the present invention, an image processing system of the color/monotone common image processing section comprises a scaling section for expanding and reducing RGB line sequential image signals selected at a selector at a certain times in horizontal scanning direction and the time difference between two neighboring colors in RGB line sequential image signals is set at an integer times of a variable read cycle of the scaling section.

According to the constitution described above, For expanding and reducing at an arbitrary ratio is possible without generating a position shift in colors because the time difference between two neighboring colors in RGB line sequential image signals is set at an integer times of a variable read cycle.

In the image processing device in the present invention, a scaling section comprises a register at which an expansion ratio and reduction ratio are set from the external and variable ratio cycle calculating section for calculating a variable read cycle from the expansion ratio and reduction ratio set at the register.

The image processing device in the present invention can response to the case where a variable read cycle varies by calculating the variable read cycle from an arbitrary setting times set at the register.

In the image processing device in the present invention, the image processing system of the color/monotone common image processing section comprises an error diffusion section for error diffusion processing the RGB line sequential image signals selected at a selector and the time difference between two colors of neighboring RGB line sequential image signals is set at non-integer times of a cycle in horizontal scanning direction of pseudo random numbers in error diffusion processing.

According to the constitution described above, even in the case of using cyclic pseudo random numbers in error diffusion processing, the image quality can be improved by not matching a random numbers pattern for each color in error diffusion processing to suppress a generation of a specific pattern.

In the image processing device in the present invention, a synchronous control for image processing is executed based on the line synchronous signal synchronized with input RGB line sequential image signals are image processed as one line signal in sequence.

By image processing the RGB line sequential image signals as one line signal in sequence, a color/monotone common image processing circuit can be controlled at the same timing as that of conventional monotone processing, a scale of circuit in the color/monotone common circuit can be reduced and the interface to a installed color processing circuit becomes simple.

In the image processing device in the present invention, a color image processing section comprises a memory control section for controlling to write RGB line sequential image signals from an external output section into a memory in RGB line sequential and to read the RGB image data corrected for a position shift for each of RGB from the memory where the same line in a line is repeated reading three times in RGB parallel and a color correction section for color correcting three RGB data read three times in parallel at the memory controlling section in line sequential.

According to the constitution described above, a correction for a position shift in reading in vertical scanning direction and color correction processing can be executed concurrently using one memory and one memory control circuit, which makes it possible to reduce the number of memories and the number of control circuits.

In the image processing device in the present invention, in the case where a color image data is input from a system bus connected to color image processing section, a memory control section writes each color of the image data input from the system bus respectively at a different address of a memory and reads the image data in RGB parallel from the memory where the same line in a line is repeated reading three times after a data transmission of a line of RGB by the system bus is finished.

According to the constitution described above, in the case where non-synchronous RGB data is input from a system bus, input buffer and color correction can be executed concurrently using one memory and one memory control circuit, which makes it possible to reduce the number of memories and the number of control circuits.

In the image processing device in the present invention, a memory control section controls memory addresses by dividing in a plurality of blocks and, while writing color image data from a system bus at an address in a block, executes concurrently data input from the system bus and color processing at the same time by reading another image data from another address in another block.

According to the constitution described above, by dividing a memory in two blocks and executing to write and read alternatively, memory write processing from the system bus and read processing for color correction are executed concurrently, which makes fast processing possible.

In the image processing device in the present invention, a color image processing section comprises a second memory control section for controlling to write RGB image data output from an image processing system in RGB line sequential into an output memory and controlling to read the RGB image data from the output memory at a data cycle required by an external equipment where the same line in a line is repeated reading four times and a color transforming section for color transform processing each line of RGB color image data read four times from the second memory control section respectively for a different color of YMCK so as to output color transforming data.

According to the constitution described above, generating RGB parallel data for color transforming RGB to YMCK and buffering to adjust output timing are executed concurrently using one memory and one memory control circuit, which makes it possible to reduce the number of memories and the number of control circuits.

In the image processing device in the present invention, in the case where an image data is input from a system bus connected to a color image processing section, a second memory control section, while writing the image data from the system bus at a different memory address for a different color in a different block from a block in which the previous line is written, concurrently reads the image data at the memory address of the block in which the previous line is written in the output memory where the same line in a line is repeated reading four times in RGB parallel.

According to the constitution described above, input buffering of the case where non-synchronous RGB data is input from the system bus, generating data for color transforming and buffering to adjust output timing can be executed concurrently using one memory and one memory control circuit, which makes it possible to reduce the number of memories and the number of control circuits.

In the image processing device in the present invention, a color transforming section uses a first color transform logic to color transform a image data that is color halftone processed and uses a second color transform logic to color transform a image data that is binary processed.

According to the constitution described above, the deterioration by print characteristics of a color printer (shift in black ink) in image quality of a color halftone image can be prevented and the reproducibility of black letters by a black ink in a color binary processed image can be maintained, which improves the image quality corresponding to the object of color image processing (halftone processing or binary processing).

In the image processing device in the present invention, a color transforming section switches the color transform logic according to the presence of black ink of a color printer as an external equipment.

According to the constitution described above, by switching the color transform logic according to the selection of halftone processing or binary processing, even in the case of out of black ink or no mount of black ink, the optimum color image can be reproduced corresponding to the condition of the black ink by outputting a normal color image with CMY ink. It results from considering that black ink is most consumed in an ordinary use.

In the image processing device in the present invention, a color image processing comprises a white balance correction data calculating section to extract the data at the assigned position from white standard image data having the number of lines corresponding to one page of the original paper provided from an external output section before scanning the original paper, writes the extracted each line and each color data respectively at a different memory address and, while reading the paper, calculates white balance correction data from the data of the line currently scanned and white standard data of the line corresponding to the current line stored in a memory.

According to the constitution described above, in a color image processing device in which white balance shift generates by light source characteristics and so on while reading one page, a color image having high image quality without white balance shift can be reproduced by correcting image quality.

In the image processing device in the present invention, a white balance correction data calculating section comprises a color correction section to matrix calculate the image data read from a memory by using the white balance correction data calculating while scanning the original paper and a predetermined color correction coefficient.

According to the constitution described above, a white balance shift correction is processed for correction at a color correction processing circuit concurrently along with a color correction, which makes it possible to reduce white balance correction circuit.

The embodiment of the present invention is explained with reference to figures in following.

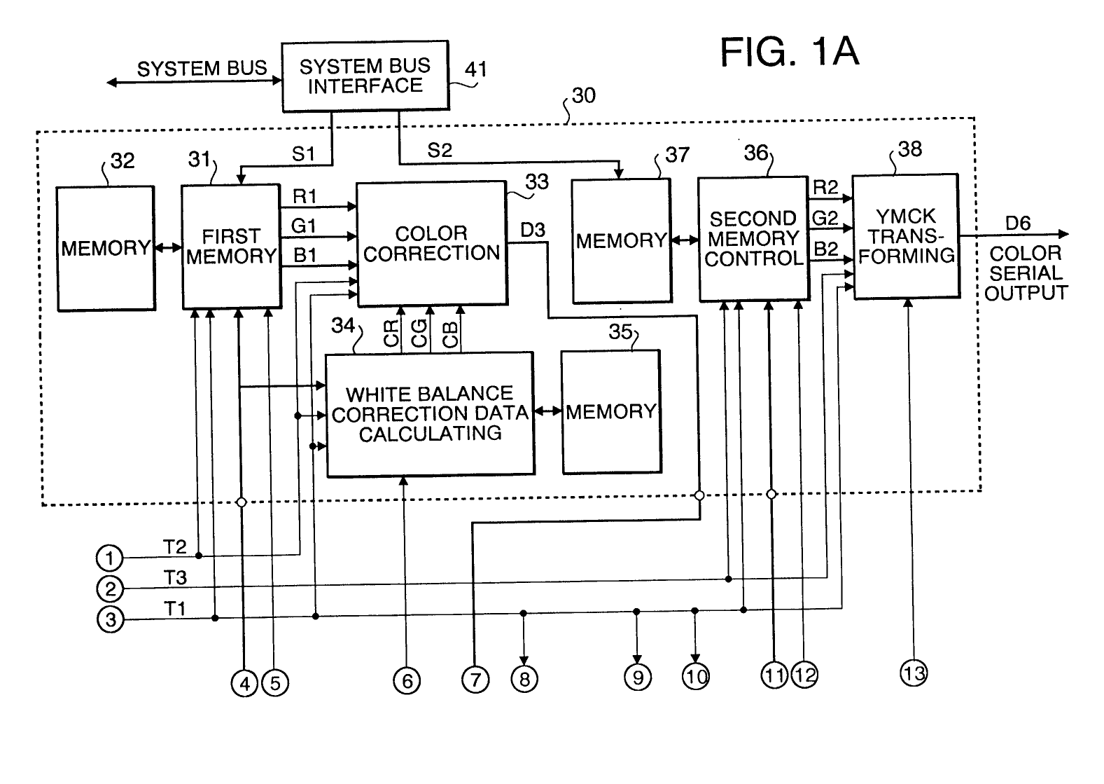

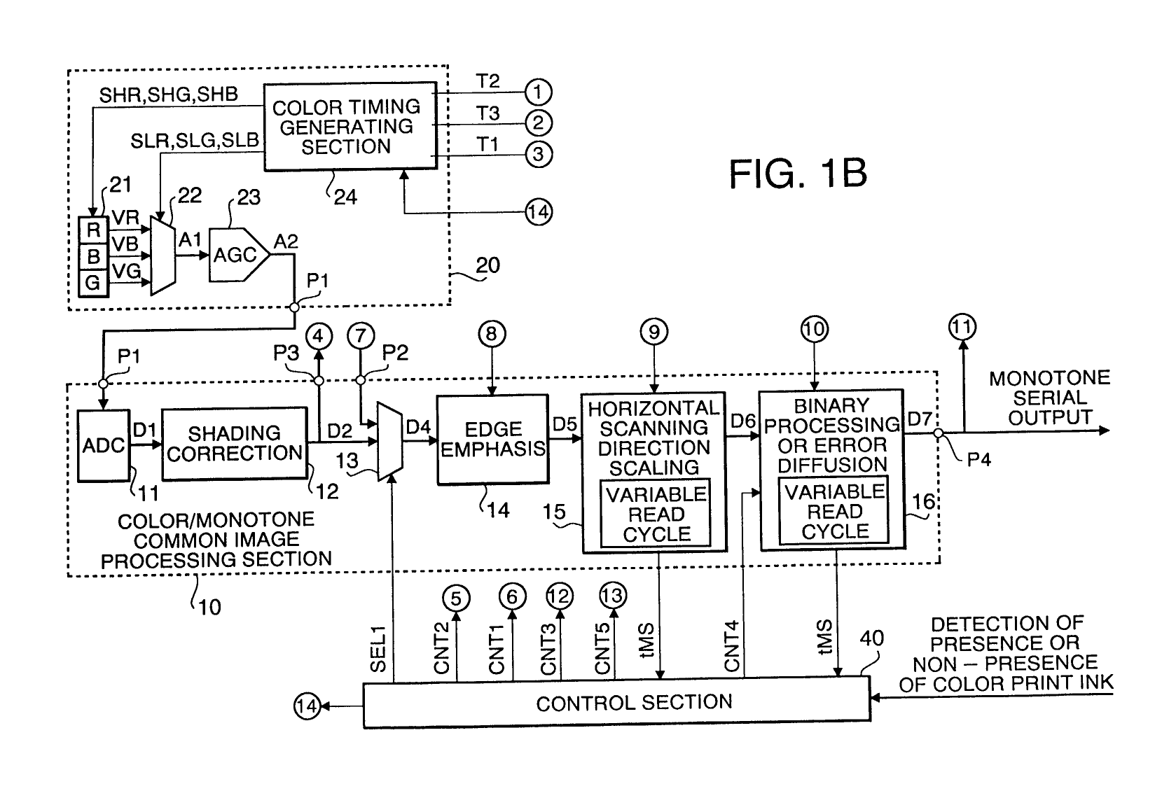

FIG. 1A and FIG. 1B illustrate function block diagrams of the whole color/monotone image processing device according to the embodiment of the present invention. The color/monotone image processing device according to the embodiment of the present invention comprises color/monotone common image processing section 10 (abbreviated as CMCP 10 in the following) to execute both of monotone image processing and a part of color image processing. At CMCP 10, external output terminal P1 is connected to color reading section 20 or monotone read section and other external output terminals P1, P2 and P3 are connected to color image processing section 30 for dealing with only color images. CMCP 10, color reading section 20, monotone read section and color image processing section 30 are controlled by a control signal from control section 40.

CMCP 10 comprises A/D converting section 11 to A/D convert image signals input from color reading section 20 or monotone read section, shading correction section 12 to shading correct output data D1 from A/D converting section 11, and selector 13 to select output data D2 from shading correction section 12 or output data D3 from external output terminals P2. Furthermore CMCP 10 comprises edge emphasis section 14 to edge emphasize image data D4 selected at selector 13, horizontal scanning direction scaling section 15 (abbreviated as HSDS 15 in the following) to variable times process output data D5 from edge emphasis section 14, and binary processing/error diffusion section 16 (abbreviated as BPED 16 in the following) to binary process or error diffusion process data D6 variable times processed. Shading correction, edge emphasis, variable times processing and binary processing/error diffusion are necessary for both of monotone image processing and color image processing. Color image processing section 30 needs the minimum functions because other functions necessary for also monotone image processing circuit are executed at CMCP 10.

Color reading section 20 comprises color CCD 21 to read an original paper, RGB line sequential processing section 22 (abbreviated as RLSP 22 in the following) to transform video signals output from color CCD 21 to line sequential signals, gain correction section 23 to gain correct RGB line sequential signals output from RLSP 22, and color timing generating section 24.

Color image processing section 30 comprises first memory control section 31 to control writing and reading input data from external output terminal P3 of CMCP 10 and input data from system bus interface 41. First memory control section 31 controls RGB parallel image signals provided into color correction circuit 33 by a write address and read cycle to memory 32. An output terminal of color correction circuit 33 is connected to external input terminal P2 of CMCP 10.

White balance correction data coefficient calculating section 34 (abbreviated as WCPC 34 in the following) calculates processes white balance correction coefficient used for matrix calculation for color correction at color correction circuit 33. White standard data to calculate white balance correction coefficient while reading an original paper is stored in memory 35.

And, color image processing section 30 comprises second memory control section 36 to control writing and reading input data from external output terminal P4 of CMCP 10 or input data from system bus interface 41. Second memory control section 36 inputs RGB parallel line sequential signals into YMCK transforming section 38 by controlling a write address and read cycle to memory 37.

Next, the operations of the image processing device according to the embodiment constituted described above are explained. In addition, CMCP 10 is connected to color reading section 20 and color image processing section 30 illustrated in FIG. 1.

Control section 40 determines the number of RGB shift clock, which is integer times of tMS and non-integer times of tES, from variable read cycle (tMS) at HSDS 15 and random numbers cycle (tES) of error diffusion processing. And, control section 40 makes color timing generating section 24 shift the timing of the number of shift clocks corresponding to each of RGB. Color timing generating section 24 generates shift gate pulse (SDR,SHG and SHB) for color CCD 21.

First, the operations of color reading section 20 are explained. Color CCD 21 generates video signals (VR,VG and VB)shifted by the number of RGB shift clocks by using shift gate pulse (SDR,SHG and SHB) provided from color timing generating section 24. At selector 22, each color of image signals is selected by RGB selecting signals (SLR,SLG and SLB) synchronized with shift gate pulse, and is composed into line sequential video signals (A1). RGB line sequential video signals gain corrected for each color (A2) at gain correction section 23 is input into CMCP 10.

Next, the operations of CMCP 10 are explained. At CMCP 10, the provided line sequential video signals (A2) are converted into digital signals at A/D converting section 11, then the converted RGB line sequential image signals Dl are input into shading correction section 12 and shading corrected as sequential one-line data synchronizing with line synchronous pulse (T1).

Shading correction section 12 has one-line memory (not shown) and reads white standard before reading an original paper, the obtained RGB line sequential image signal data is stored as one-line data in the one-line memory and each of pixels is respectively shading corrected by the white standard data.

The RGB line sequential image signals shading corrected are output to color image processing section 30 from external output terminal P3 of CMCP 10 as a shading correction data. The RGB line sequential image data color corrected at color image processing section 30 which is synchronized with shading correction output is concurrently input from external output terminal P2 of CMCP 10. The shading correction data and the image data input from the external input are selected at selector 13 controlled by control signal (SEL1).

At selector 13, in the case where shading correction output (P3) of CMCP 10 and image data input (P2) are connected to color image processing section 30 and color reading section 20 illustrated in FIG. 1, the image data input from external input terminal P2 is selected and, in the case where shading correction output (P3) and image data input (P2) are not connected to color image processing section 30 or connected to monotone reading section, the shading correction output from shading correction section 12 is selected. Namely, in the case of executing color image processing, color correction processing which monotone image processing circuit can not deal is provided to color image processing section 30, and the color correction result of color image processing section 30 is acquired.

In the case of selecting RGB line sequential image data provided from color image processing section 30 at selector 13, while RGB line sequential image data is written in the line memory (not shown) at edge emphasis section 14 as an one-line image signal, edge emphasis processing is executed by the image data and the image data read from the line memory.

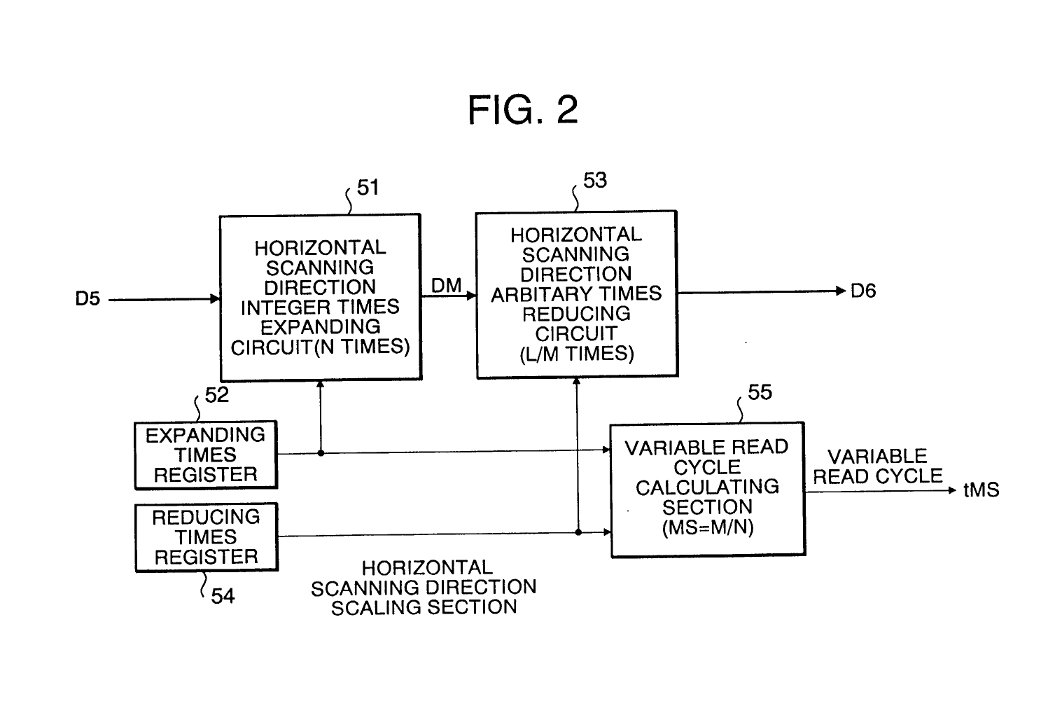

HSDS 15 expands or reduces RGB line sequential image data as an one-line image signal at a certain times in horizontal scanning direction. FIG. 2 illustrates a circuit configuration of HSDS 15. HSDS 15 expands the provided image signal (D5) at horizontal scanning direction integer expansion circuit 51 (abbreviated as HSEC 51 in the following) at N times of an integer value according to the setting of expansion times register 52, reduces its output (DM) at horizontal scanning direction arbitrary reducing circuit 53 (abbreviated as HSRC 53 in the following) at L/M times according to the setting of reducing ratio register 54 so as to scale at (N×L)/M of an arbitrary variable times.

The insert position of an image in expanding and the omitted position of an image in reducing have a constant variable read cycle (tMS) to input image data (D5) and the variable read cycle is calculated from the setting values of expansion times register 52 and reducing ratio register 54 at variable read cycle calculating section 55 (abbreviated as VRCC 55 in the following). HSEC 51 executes the processing to generate N pixels in a cycle for one pixel in the input image. HSRC 53 executes the pixel omitting processing to leave L pixels in every M pixels in the N times expanded image and omit the pixels corresponding to a difference between M pixels and L pixels. Accordingly, the variable read cycle:MS to input image data is MS=M/N(pixels). Control section 40 detects MS as a variable read cycle from VRCC 55. In addition, as a calculating circuit for omitting pixel position at HSRC 53, a conventional calculating circuit is available, for instance, the circuit described in Japanese unexamined patent application NO.1-233963 is utilized.

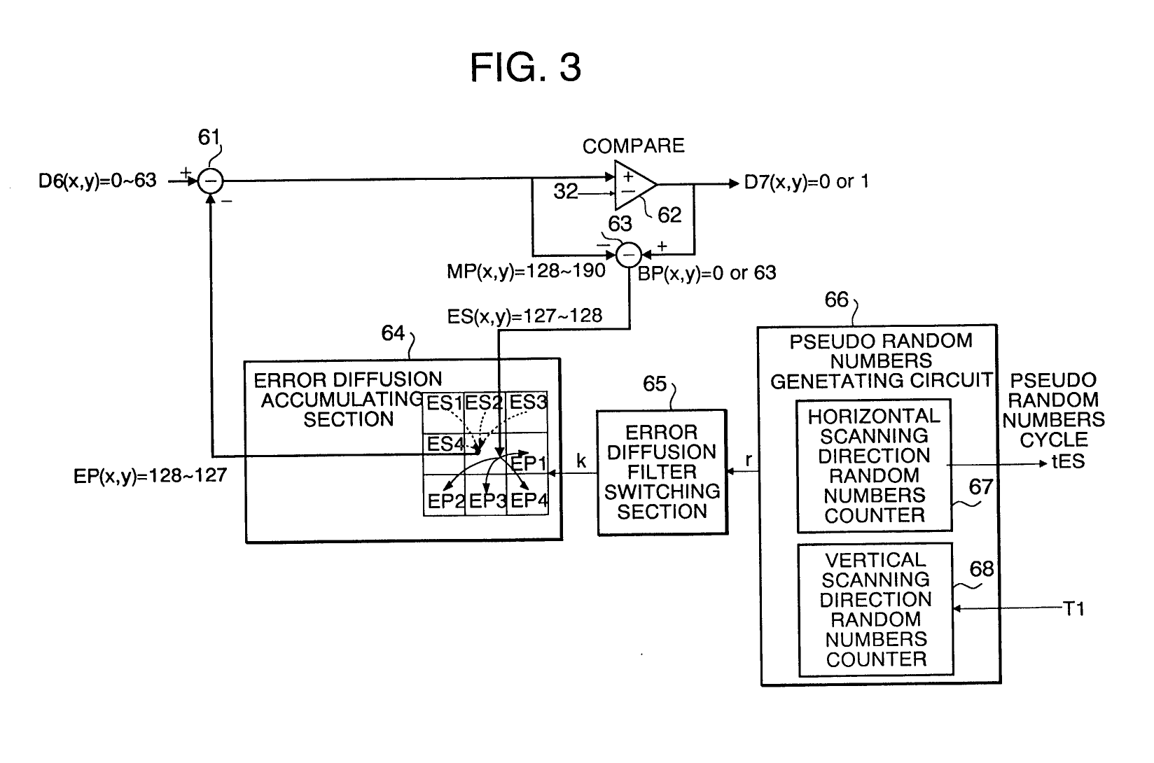

At BEDP 16, binary processing or error diffusion processing are executed according to the setting of a control signal (CNT4). FIG. 3 illustrates a circuit configuration of BEDP 16. At substracter 61, quantization error in already binary processed image is corrected. The corrected data MP(x,y) is; MP(x,y)=D6(x,y)−EP(x,y). D6 is input data and EP(x,y) is the sum total of quantization error propagated from the already binary processed peripheral pixels;

{D6(x−1,y−1),D6(x,y−1),D6(x+1,y−1),D6(x−1,y)}.

Comparator 62 quantinizes (binary processes) the corrected data MP(x,y). In the case of MP(x,y) 32, output D7=1(white), and BP=63 are provided as an output. In the case of MP(x,y)<32, output D7=0(black) and BP=0 are provided as an output.

Subtracter 63 calculates quantization error from MP(x,y) that is the data before quantization and BP (x,y) that is the data after quantization following the formula below.

ES(x,y)=BP(x,y)−MP(x,y)

The calculated result ES (x,y) is stored at error diffusion accumulating section 64.

The quantization error of peripheral pixels around input data D6 (x,y) is read from error diffusion accumulating section 64 and the sum total of quantization error of peripheral pixels is subtracted from the input data D6 (x,y).

At this time, the quantization error of peripheral pixels is multiplied error diffusion filter coefficient following the formula below and the result is stored at error diffusion accumulating section 64.

EP(x+1,y)=EP(x+1,y)+K(1,0,r)*ES(x,y)

EP(x−1,y+1)=EP(x−1,y+1)+K(−1,1,r)*ES(x,y)

EP(x,y+1)=EP(x,y+1)+K(0,1,r)*ES(x,y)

EP(x+1,y+1)=K(1,1,r)*ES(x,y)

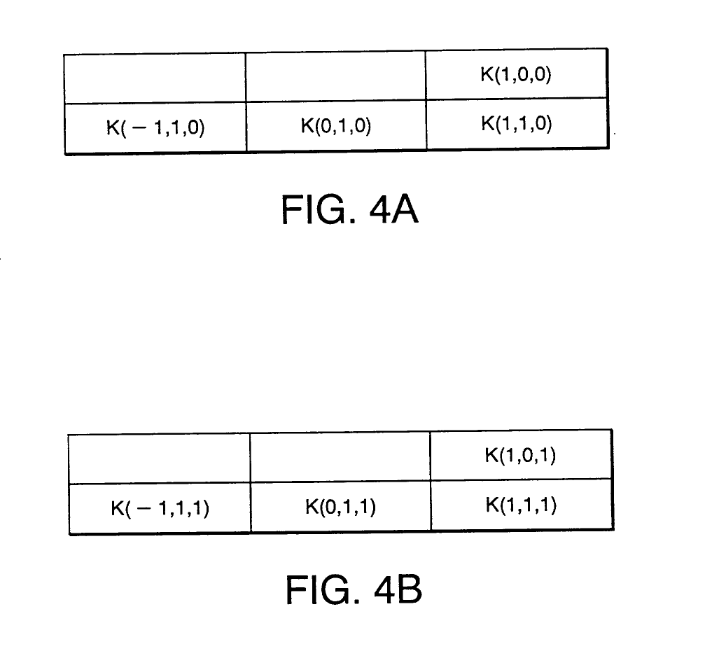

In the above, K(m,n,r) is a error diffusion filter. As illustrated in FIG. 4A and FIG. 4B, the image processing device in this embodiment has two error diffusion filters, which are switched at error diffusion filter switching section 65 (abbreviate as EDFS 65 in the following).

Concretely, pseudo random numbers generating circuit 66 (abbreviate as PRNG 66 in the following) comprising horizontal scanning direction random numbers counter 67 (abbreviate as HSRC 67 in the following) and vertical scanning direction random numbers counter 68 (abbreviate as VSRC 68 in the following) for switching an error allocation coefficient generates random numbers of a constant cycle in horizontal scanning direction and in vertical scanning direction. Control section 40 detects a horizontal scanning direction random numbers cycle as a pseudo random numbers cycle:ES (pixel).

At BPED 16, RGB line sequential image data is binary processed or error diffusion processed as an one-line image signal and serial output from external output terminal P4 to color image processing section 30. In the case where color image processing section 30 is not connected, the data is monotone output from external output terminal P4.

Next, the operations of color image processing section 30 are explained.

The RGB line sequential image data signals which is provided from external output terminal P3 given shading correction output of CMCP 10 are written into a different memory block for each color in memory 32 by first memory control section 31. First memory control section 31 reads the image data of RGB three colors at the same read position in reading and repeats it three times to get the same data for three lines in synchronized with a synchronous signal (T2) to output RGB parallel image signals (R1,G1 and B1).

A synchronous signal (T2) contains three synchronous pulses having the same timing with shift gate pulse (SHR,SHG and SHB) in a line. The interval of three synchronous pulses is an integer times of variable read cycle (tMS) of HSDS 15 and a non-integer times of random numbers cycle (tES) of error diffusion processing. Accordingly, the same line data is output for three lines as RGB parallel image signals (R1,G1 and B1) at synchronous pulse intervals.

And, first memory control section 31 stores the image data of the line number corresponding to an RGB read position shift of color CCD 21 at memory 32, reads the line data corresponding to the same read position, and corrects the RGB read position shift of color CCD 21.

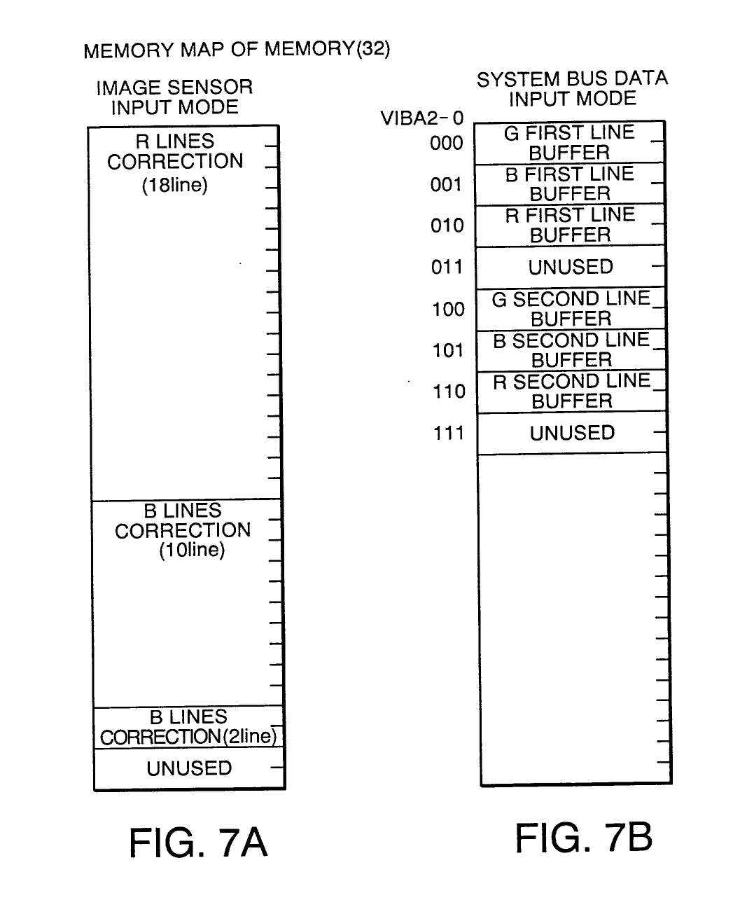

Illustrated in a memory map of memory 32 in FIG. 7A, a block of each color has a capacity of different lines for each color and an write address is periodically accessed as an address of the line assigned as a read address.

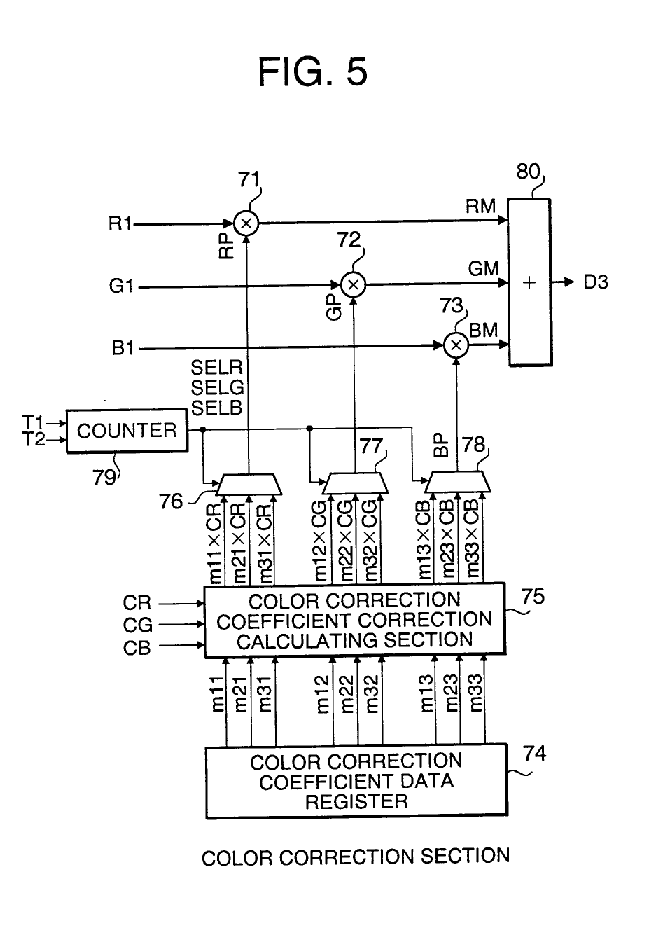

The three lines of RGB parallel image signals (R1,G1 and B1) repeatedly output are matrix calculated and color corrected at color correction section 33. FIG. 5 illustrates a circuit configuration of color correction section 33. The RGB parallel image signals provided from first memory control section 31 are input to multiplier 71, 72 and 73 and multiplexed matrix coefficient RP, GP and BP which are switched according to each line. Color correction coefficient correction calculating section 75 (abbreviate as CCCC 75 in the following) white balance corrects color correction coefficient m11 to m33, which are stored in color correction coefficient data register 74 (abbreviated as CCCR 74 in the following), using white balance correction coefficient CR,CB and CG. CCCC 75 generates matrix coefficients of 3×3, which are selected at one line unit by selector 76 to 78 respectively corresponding to multiplier 71 to 73 and are set respectively at multiplier 71 to 73. Selector 76 to 78 switch the output coefficients using the selection signal output by counter 79.

Color correction section 33 described above correction calculates the first line of repeated three lines of RGB parallel image signals for R, the second line for G and the third line for B, outputs the color correction resultant in order of the calculation in RGB line sequential, and inputs the resultant to external input terminal P2 of CMCP 10 as an image data input.

The matrix calculation formula 1 processed at color correction section 33 is as follows.

[Formula 1]

$$[ \begin{matrix}R3 \\ G3 \\ B3\end{matrix} ] = [ \begin{matrix}m11 \cdot CR & m12 \cdot CG & m13 \cdot CB \\ m21 \cdot CR & m22 \cdot CG & m23 \cdot CB \\ m31 \cdot CR & m32 \cdot CG & m33 \cdot CB\end{matrix} ] \times [ \begin{matrix}R1 \\ G1 \\ B1\end{matrix} ]$$

m11 to m33: predetermined color correction coefficient CR, CB, CG white balance correction coefficient

(Here; each is 1 in the case of no white balance shift)

Correction calculation processing for the first line SELR is valid, SELG and SELB are invalid by counter output, then

RP=m11·CR;

GP=m12·CG; and

BP=m13·CB.

Color correction calculating result D3 for R is as follows.

D3(R3)=m11·CR·R1+m12·CG·G+m13·CB·B1

Correction calculation for the second line SELG is valid, SELB and SELR are invalid by counter output,

then

RP=m21CR;

GP=m22·CG; and

BP=m23·CB.

Color correction calculating result D3 for G is as follows.

D3(G3)=m21·CR·R1+m22·CG·G1+m23·CB·B1

Correction calculation for the third line SELB is valid, SELG and SELR are invalid by counter output,

then

RP=m31·CR;

GP=m32·CG; and

BP=m33·CB.

Color correction calculating result D3 for B is as follows.

D3(B3)=m31·CR·R1+m32·CG·G1+m33·CB·B1

CCCC 75 multiplies color correction coefficient (m11 to m33) predetermined at CCCR 74 by white balance correction data (CR,CG and CB) input from WCPC 34 in the combination described above at the timing of line synchronous pulse (T1)“H” to obtain each component value of the matrix.

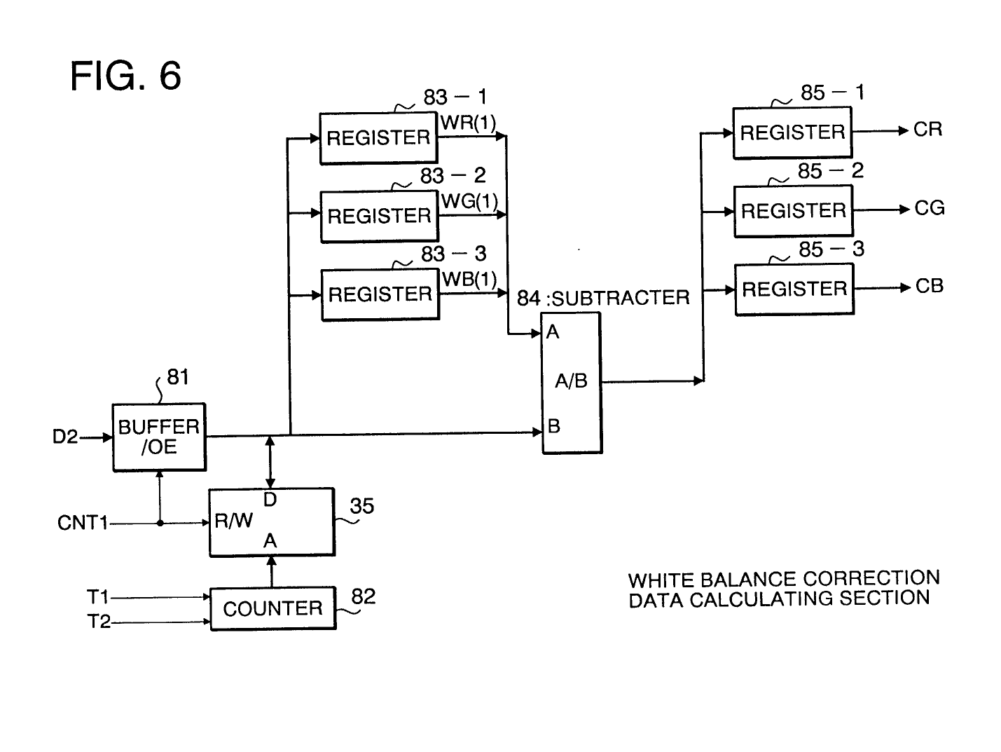

FIG. 6 illustrates a circuit structure of WCPC 34.

Before scanning an original paper, white standards of the number of lines corresponding to one page of the original paper are read as white balance training, its RGB line sequential signals are shading corrected at shading correction section 12 concurrently while reading an original paper. At WCPC 34, each of RGB on the pixel at an assigned pixel (for example, center position) of the shading corrected data is respectively extracted, a memory address is generated from a line counter value at counter 82 and RGB input timing and the extracted white standard data is written into memory 35. And, another example is that the pixels at the former and latter position of an assigned position are extracted to reduce error caused by noise and the calculated average value is written into memory 35.

White balance shift is caused by a fluctuation of light amount ratio from a light source to read colors in a time of reading one page(VR:VG:VB). The pattern of the fluctuation differs delicately according to the product variability of a light source, environment temperature, aging variation and others. Because white balance shift does not differ every page, it is useful to storage the data of white balance training in a nonvolatile storage as a default value when the device is manufactured, and, in the case where the deterioration in image quality occurs, execute white balance training by a handling of a device operator using the stored data of white balance training. Otherwise, another method is to run it automatically at a constant interval in which a device is unused.

The white balance correction data (CR, CG and CB) is calculated at every line on the based on with write balance data written in memory 35 while reading. In the calculation, the data for the first line [WR(1), WG(1) and WB(1)] are read from memory 35 and stored at register 83-1 to 83-3 respectively corresponding to each color. Next, the data for a current line [WR(n), WG(n) and WB(n)] stored in buffer 81 are read, which is input into subtracter 84 along with the data for the first line. Then, the calculation shown in the following formula is executed and the resultant data are stored in registers for each color (85-1 to 85-3) before starting color correction for the current line.

CR=WR(1)/WR(n)

CG=WG(1)/WG(n)

CB=WB(1)/WB(n)

Next, RGB line sequential color image signals binary processed or error diffusion processed at CMCP 10 are again input into color image processing section 30 and written into a different memory block for each color in memory 37 by second memory control section 36.

Second memory control section 36, while write processing, concurrently reads the image data of three colors of RGB on the same pixel from the different memory block for each color in memory 37, repeats it to obtain the same data for four lines synchronizing with a synchronous signal(T3) and outputs RGB parallel image signals (R2, G2 and B2).

At YMCK transforming section 38, the RGB parallel image signals (R2, G2 and B2) repeated for four lines are color transformed according to the logic formula described later. In the RGB parallel image signals repeated for four lines, the transforming calculation for C (cyan) is executed with the first line, the transforming calculation for M (magenta) is executed with the second line, the transforming calculation for Y (yellow) is executed with the third line, the transforming calculation for K (carbon) is executed with the first line, and those are output serially in order of the calculation as a CMYK line sequential image data.

The color transforming logic formula is switched by the selection of color letters (binary processing) or color halftone (error diffusion) and the presence of K (black) ink of a color printer, on which information is provided to control section 40.

In the case of color letters (binary procession) and the presence of K(black) ink of a color printer, color transforming logic formula 1 is as follows.

C=/R·(G+B)

M=/G·(R+B)

Y=/B·(R+G)

K=/R·/G·/B

In the case of color halftone (error diffusion) or non- presence of K (black) ink of a color printer, color transforming logic formula 2 is as follows.

C=/R

M=/G

Y=/B

K=0

The cases having two conditions are explained above however either of the conditions may be enough to switch the logic formula.

The switching of the processing by the conditions of color letters (binary processing) and color halftone (error diffusion) can prevent the deterioration in a halftone image, in the case of poor printing precision which results in generating a shift between a printing dot of CMY and a printing dot of K.

Because the shift of 1/n (n>1) at a printing position of a pixel results in deterioration of the tone reproducibility in a halftone image, in the case of a halftone image, the tone reproducibility is improved by printing with composite black composed of CMY without printing a K dot which makes a shift against a CMY dot.

In a printer having good printing precision, color transforming logic formula 1 is used without switching by the condition of color letters (binary processing) and color halftone (error diffusion).

Next, the operations of the case of image processing by inputting data through system bus interface 41 from a system bus of CPU are explained.

In the case of inputting full color data having 8 bits/pixel for each of RGB, the full color data is input in RGB line sequential into first memory control section 31 via a signal bus (S1).

The memory map of memory 32 at this time is changed to the configuration divided into two blocks in a memory area for inputting system bus data illustrated in FIG. 7B.

In the system bus data input mode, it is not necessary to correct a shift of read position which increases memory capacity. By using it efficiently, two more blocks in a memory area in memory 32 are obtained and the number of pixels a line increase to two times.

First memory control section 31 switches shading correction data (D2) to bus input data (S1) by a control signal (CNT2), assigns another block differing from a block in which a previous line is written in memory 32 and writes the data (S1) into the assigned block in memory 32 in RGB line sequential.

First memory control section 31, while write processing, concurrently reads image data of RGB three colors from a block in which the previous line is written in memory 32 and repeats it three times to obtain the same data for three lines synchronizing with a synchronous signal (T2) to output RGB parallel image signals (R1, G1 and B1).

The interval of three synchronous pulses of a synchronous signal (T2) is an integer times of variable read cycle (tMS) of HSDS 15 and non-integer times of random numbers cycle (tES) of error diffusion processing. Accordingly, the RGB parallel image signals (R1, G1 and B1) are output three times to obtain three lines of the same line data at an interval of the synchronous pulses. The color correction processing below is the same as the image processing at color reading section 20 when reading.

Next, the case of inputting color halftone data or color binary data having 1 bit/pixel for each of RGB is explained. Color halftone data or color binary data is input into second memory control section 36 in RGB line sequential via signal bus S2.

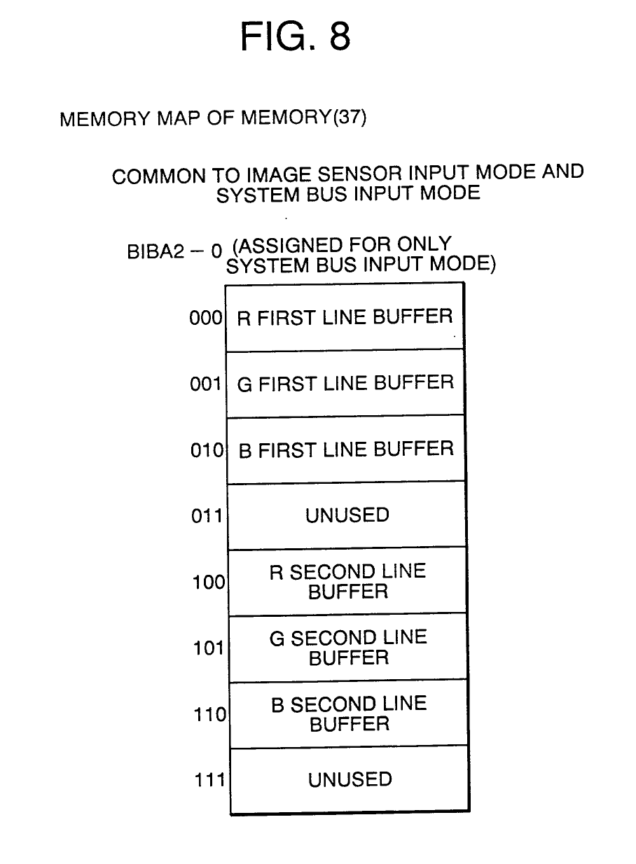

The memory map of memory 37 at this time is the same as when reading at color reading section 20 having the configuration divided into blocks illustrated in FIG. 8.

Second memory control section 36 switches RGB line sequential color image signals (D7) binary/error diffusion processed to the bus input system data (S2) by a control signal (CNT3), assigns another block differing from a block in which a previous line is written and writes the data(S2) into the assigned block in memory 37 in RGB line sequential.

Second memory control section 36, while the write processing, reads image data of the three colors of RGB from a block in which a former line is written in memory 37 and repeats it four times to obtain the same data for four lines synchronizing with a synchronous signal (T3) to output RGB parallel image signals (R2, G2 and B2). The TMCK transforming processing at TMCK transforming processing section 38 in the following is the same as the image processing at color reading section 20 in reading.

In both of two modes inputting data from a system bus described above, they have a condition that an image processing of a line and a data transmitting of a line from a system bus starts after the image processing of another line and the data transmitting of another line are finished.

As described above, the high speed processing can be achieved by executing data transmitting from a system bus and image processing concurrently.

According to the embodiment of the present invention, by installing color image processing section 30 as an optional circuit at CMCP 10 having the function as a monotone image processing device, it can be modified easily to color image processing device keeping monotone image processing circuit active. In this case, the color optional circuit needs only minimum functions because a monotone image processing circuit also executes a part of color image processing, which makes inexpensive downsizing possible.

And, by integrating CMCP 10 to LSI, the LSI can be used in common for a color device and a monotone device. The substrate for main image processing is applied also in common for the color device and the monotone device which makes it possible to reduce cost in development and manufacturing of products and reduce product parts to control.

In the embodiment described above, external output terminal P3 and P2 and selector 13 are placed between shading correction and edge emphasis. However, image data can be taken in and out to and from any part of image processing system at CMCP 10.

The present invention described in detail can provide a image processing device capable of changing a monotone image device to a color image device easily and inexpensively only by installing a color optional circuit.

What is claimed is:

1. An image processing device wherein an image processing system for executing a series of image processing corresponding to a monotone image also executes a part of color image processing common to said monotone image processing.

2. An image processing device has a color/monotone common image processing section comprising:
an image processing system for executing a series of image processing corresponding to a monotone image;
an external output section for taking out intermediate processing data from said image processing system to an external;
an external input section for taking in color processed image data from the external to an intermediate section of the image processing system; and
a selector to select either of the image data provided from said external input section and the intermediate processing data provided from a former section of said image processing system to obtain the data to the intermediate section of said image processing system.

3. The image processing device according to claim 2, wherein the color/monotone common image processing section is connected to a color image processing section for color processing the intermediate processing data provided from the external output section so as to input to the external input section.

4. The image processing device according to claim 3, wherein the color image processing section comprises a color transforming output section for taking in RGB image data output of the image processing system from the color/monotone common image processing section and color transforming it into the color system data appropriate for an external equipment so as to output.

5. The image processing device according to claim 2, wherein the image processing system of the color/monotone common image processing section comprises a scaling means for expanding and reducing RGB line sequential image signals selected at the selector at a certain times in horizontal scanning direction, and the time difference between two neighboring colors in RGB line sequential image signals is set at an integer times of a variable read cycle of said scaling means.

6. The image processing device according to claim 5, wherein the scaling means has a register at which an expansion ratio and reduction ratio are set from the external, and variable read cycle calculating means calculates a variable read cycle from the expansion ratio and reduction ratio set at said register.

7. The image processing device according to claim 2, wherein the image processing system of the color/monotone common image processing section comprises error diffusion means for error diffusion processing the RGB line sequential image signals selected at the selector, and the time difference between two colors of neighboring RGB line sequential image signals is set at non-integer times of a cycle in horizontal scanning direction of pseudo random numbers in error diffusion processing.

8. The image processing device according to claim 2, wherein a synchronous control for image processing is executed based on the line synchronous signal synchronized with input RGB line sequential image signals, and the input RGB line sequential image signals are image processed as one line signal in sequence.

9. The image processing device according to claim 3, wherein the color image processing section comprises:
memory control means for controlling to write RGB line sequential image signals from the external output section into a memory in RGB line sequential and for controlling to read the RGB image data corrected for a position shift for each of RGB from the memory where the same line in a line is repeated reading three times in RGB parallel; and
color correction means for color correcting the RGB three image data read three times in parallel by said memory control section in line sequential.

10. The image processing device according to claim 9, wherein in the case where a color image data is input from a system bus connected to the color image processing section, the memory control section writes each color of the image data input from the system bus respectively at a different address of a memory and reads the written image data from said memory where the same line in a line is repeated reading three times in RGB parallel, after a data transmission of a line of RGB by the system bus is finished.

11. The image processing device according to claim 10, wherein the memory control means controls memory addresses by dividing in a plurality of blocks, writes the color image data from the system bus at an address in a block and executes concurrently data input from the system bus and color processing by reading color image data from an address in another block.

12. The image processing device according to claim 3, wherein the color image processing section comprises:
second memory control means for controlling to write the RGB image data output from said image processing system in RGB line sequential into an output memory and for controlling to read the RGB image from the output memory at a data cycle required by an external equipment where the same line in a line is repeated reading four times in parallel; and
color transforming means for color transform processing each line of the RGB color image data read four times from said second memory control means respectively for a different color of YMCK to output color transforming data.

13. The image processing device according to claim 12, wherein in the case where an image data is input from the system bus connected to the color image processing section, the second memory control means, writes the image data from the system bus at a different memory address for a different color in another block differing from a block in which the previous line is written, and reads concurrently the image data from the memory address of the block in which the previous line is written in the output memory where the same line data is repeated reading four times in RGB parallel.

14. The image processing device according to claim 12, 15 wherein color transforming means executes color transforming on the basis of the first color transform logic in the case of color transforming an image data color-halftone processed and executes color transforming on the basis of the second color transform logic in the case of color transforming an image data binary processed.

15. The image processing device according to claim 12, wherein the color transforming means switches the color transform logic according to the presence of black ink of a color printer as an external equipment.

16. The image processing device according to claim 3, wherein the color image processing means comprises white balance correction data calculating means for extracting the data at the assigned position from white standard image data having the number of lines corresponding to one page of the original paper provided from the external output section before scanning the original paper to write the extracted each line and each color data respectively at a different memory address and for calculating white balance correction data from the data of the line currently scanned and white standard data of the line corresponding to the current line stored in a memory in reading the paper.

17. The image processing device according to claim 16, wherein the white balance correction data calculating means comprises color correction means for matrix calculating the image data read from a memory by using the white balance correction data calculated in scanning the original paper and a predetermined color correction coefficient.
